(19) United States
(12) Patent Application Publication
(10) Pub. No.: US 2017/0164779 A1
(43) Pub. Date: Jun. 15, 2017

(54) DISPOSABLE TRAY FOR FOOD STEAMER

(71) Applicant: Yong Gi CHOI, Chuncheon-si, Gangwon-do (KR)

(72) Inventor: Yong Gi CHOI, Chuncheon-si, Gangwon-do (KR)

(21) Appl. No.: 15/319,391

(22) PCT Filed: Aug. 18, 2015
(86) PCT No.: PCT/KR2015/008571

§ 371 Date: Dec. 16, 2016

(30) Foreign Application Priority Data
Aug. 18, 2014 (KR) 10-2014-0107244
Oct. 1, 2014 (KR) 10-2014-0132504

(51) Int. Cl. A47J 27/04; A47J 36/16; A47J 36/04

(52) U.S. Cl. CPC A47J 27/04; A47J 36/04; A47J 36/16

(57) ABSTRACT

The present invention relates to a disposable tray for a food steamer, comprising: a support that stands upright in a vessel while being supported, at the lower end portion thereof, by the vessel; and an upper plate that is horizontally formed on the upper portion of the support to have a predetermined area and has a plurality of through-holes formed therein. The support is bonded to the lower surface of the upper plate, or is separated from, or coupled to, the upper plate through a coupling part that is formed on the upper end of the support and is inserted into and coupled to a slit formed in the upper plate. Alternatively, the support is formed on one side or on opposite sides of the upper plate and is bent with respect to a folding hole or folding line, which is formed at the portion where the upper plate and the support are connected to each other, so as to be perpendicular to the upper plate and to be disposed to face each other, wherein opposite end portions of the support cross each other such that insertion grooves thereof are coupled to each other, thereby forming a side wall. Therefore, it is possible to cook in a convenient and sanitary manner by using the disposable tray for a food steamer according to the present invention. In addition, it is also possible to conveniently cook frozen food in steam outdoors.

### TECHNICAL FIELD

The present invention relates to a disposable tray for a food steamer, and more particularly to a disposable tray for a food steamer which is placed in a cooking pot or a microwave oven and allows food to be placed thereon to cook the food by steam or a heat source.

### BACKGROUND ART

Generally, frozen foods such as rice cake, dumplings, red bean buns, and the like are eaten after steaming in a steamer or cooking in a microwave oven. In steaming, a tray to allow food to be placed thereon in a steamer is configured separately from a bottom surface of a container, food is mounted on the tray, the steamer is filled with a certain amount of water to a portion thereof below the tray, and then the food is heated to be cooked by steam. A tray is made of a stainless plate and is provided with fine through-holes formed therein to be easily heated.

Korea Utility Model Registration No. 20-0287436 discloses a support plate for steaming food. As for the support plate, in a state in which meat is mounted on the support plate supported in a pot containing soup instead of being immersed in the soup when heating, contents such as meat and the like are cooked by steam generated by heating of the soup and thus, while eating the cooked contents, such as boiled beef or pork slices, the soup below the support plate during heating can be conveniently eaten.

When frozen foods are cooked, however, a separate steamer is conventionally required and thus there are inconveniences in cooking thereof. In addition, when cooking food using a microwave oven, food put in a container such as a plate is cooked in the microwave oven by heating for a certain period of time and, in this case, a bottom surface of the food contacts the plate and thus heat is not uniformly applied thereto and, accordingly, the food is incompletely cooked or soggy due to moisture therein, resulting in poor taste thereof.

### DISCLOSURE

### Technical Problem

The present invention has been made in view of the above problems, and it is one object of the present invention to provide a disposable tray for a food steamer which may be applied to both a steamer using steam and a microwave oven for heating using microwaves, may be simply assembled and thrown away after one use, resulting in enhanced hygienic properties, and is convenient to use.

### Technical Solution

In accordance with one aspect of the present invention, provided is a disposable tray for a food steamer, including: a support standing upright such that a lower end portion thereof is supported in a container; and an upper plate horizontally disposed on an upper portion of the support, having a certain area, and having a plurality of through-holes formed therein, wherein the support is provided with adhesion pieces at an upper portion thereof and the adhesion pieces are adhered to a bottom surface of the upper plate.

In accordance with another aspect of the present invention, provided is a disposable tray for a food steamer, including: an upper plate having a certain area and with a plurality of through-holes formed therein; and a support(s) connected to one side or opposite sides of the upper plate and provided with insertion grooves at opposite end portions of each thereof, wherein a folding line or a folding hole is formed at a connection portion between the support and the upper plate, the support is folded along the folding line or the folding hole to stand in a direction perpendicular to the upper plate, opposite end portions of the support intersect each other and the respective insertion grooves are combined with each other to form a sidewall so that the support stands upright on an inner side of the upper plate.

In accordance with yet another aspect of the present invention, provided is a disposable tray for a food steamer, including: an upper plate having a certain area and with a plurality of through-holes formed therein; and a support connected to one side of the upper plate and provided with an adhesion piece(s) at an upper portion(s) of one side or opposite sides thereof, wherein a folding line or a folding hole is formed at a connection portion between the support and the upper plate, the support is folded along the folding line or the folding hole to stand in a direction perpendicular to the upper plate to form a sidewall so that the support stands upright.

The disposable tray further includes an auxiliary support inserted into the support and supporting a center of the upper plate, wherein the auxiliary support is formed by vertically folding cardboard in a “>” shape such that an upper end thereof support a bottom surface of the upper plate and a lower end thereof supports a bottom surface of a container.

The support has a tetragonal, polygonal or cylindrical form and is provided with a plurality of folding lines or cutting lines to be folded and cut.

### Advantageous Effects

As apparent from the fore-going description, the present invention advantageously provides a simple disposable tray that enables convenient cooking, is hygienic, and enables convenient cooking of frozen foods by steam while outdoors.

In addition, while conventional trays require a separate separating member such as fabric, paper, or the like so that frozen food is easily separated from a tray after cooking, a disposable tray according to the present invention enables frozen food to be easily separated therefrom and thus is convenient to use.

### DESCRIPTION OF DRAWINGS

FIG. 1 is an exploded perspective view of a disposable tray for a food steamer, according to a first embodiment of the present invention.

FIG. 2 is a combined cross-sectional view of the disposable tray according to the first embodiment of the present invention.

FIG. 3 is a view illustrating a folded state of a support of the disposable tray according to the first embodiment of the present invention.

FIG. 4 is a view illustrating an unfolded state of the support.

FIGS. 5 and 6 are perspective views illustrating different examples of a support of a disposable tray for a food steamer, according to a second embodiment of the present invention.

FIG. 7 is a development view of a disposable tray for a food steamer, according to a third embodiment of the present invention.

FIGS. 8 and 9 are a development view and a combined perspective view that illustrate the disposable tray according to the third embodiment of the present invention.

FIGS. 10 and 11 are a development view and a combined bottom view that illustrate a disposable tray for a food steamer, according to a fourth embodiment of the present invention.

FIGS. 12, 13 and 14 are a development view and a combined perspective view that illustrate other examples of the disposable tray according to the fourth embodiment of the present invention.

FIG. 15 is a development view of a disposable tray for a food steamer, according to a fifth embodiment of the present invention.

FIGS. 16, 17 and 18 are a development view, an assembled perspective view, and a bottom view that illustrate a disposable tray for a food steamer, according to a sixth embodiment of the present invention.

FIG. 19 illustrates development views of a disposable tray for a food steamer, according to a seventh embodiment of the present invention.

FIG. 20 illustrates combined perspective views of the disposable tray of FIG. 19.

FIG. 21 is a development view of a disposable tray for a food steamer, according to an eighth embodiment of the present invention.

FIG. 22 is a bottom view illustrating an auxiliary support applied to disposable trays for a food steamer, according to various embodiments of the present invention.

FIGS. 23, 24 and 25 are views illustrating various examples of a support of a disposable tray for a food steamer according to the present invention.

FIG. 26 is a plan view illustrating another example of an upper plate of a disposable tray for a food steamer according to the present invention.

FIG. 27 is a view illustrating another example of a through-hole of an upper plate of a disposable tray for a food steamer according to the present invention.

### BEST MODE

A disposable tray for a food steamer according to the present invention includes: an upper plate having a certain area and with a plurality of through-holes formed therein; and first and second supports having a rectangular form to be symmetric to each other at opposite sides of the upper plate and provided with insertion grooves formed therein, in which the first support and the second support are configured opposite to each other to be perpendicular to the upper plate, and opposite end portions of the first support and the second support intersect each other and the respective insertion grooves of the first and second supports are combined with each other, thereby forming sidewalls.

### MODE OF THE INVENTION

Hereinafter, exemplary embodiments of the present invention will be described in detail with reference to the accompanying drawings.

The embodiments described below are provided only for illustrative purposes in such a way that the invention may be easily carried out by one of ordinary skill in the art to which the present invention pertains and are not to be construed as limiting the technical idea and scope of the present invention.

In addition, the size or shape of each element in the drawings can be exaggerated for clarity and convenience of explanation. Terms particularly defined in consideration of configuration and function of the present invention may vary according to intents or precedents of users or operators, and these terms must be defined based on the contents of the present specification.

### First Embodiment

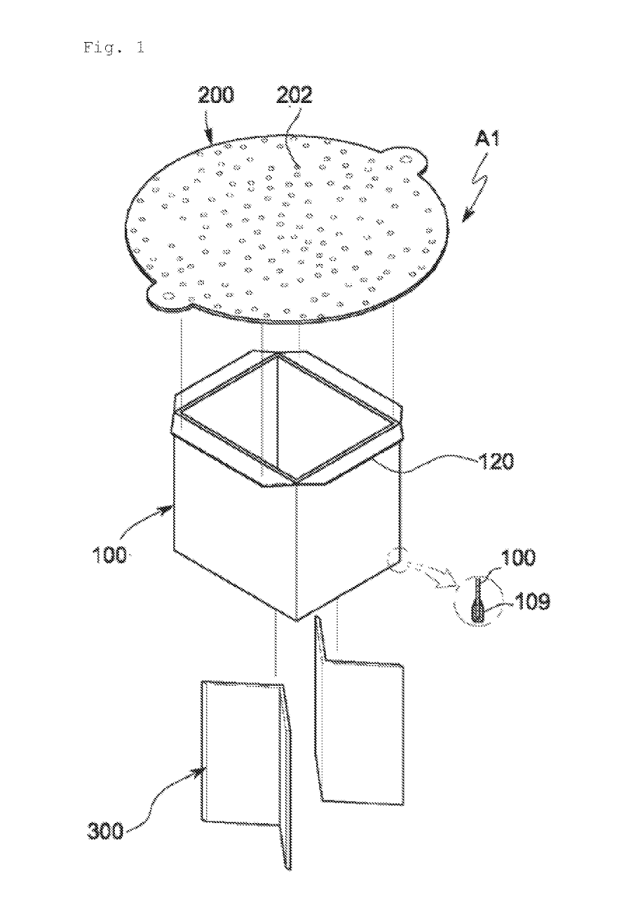

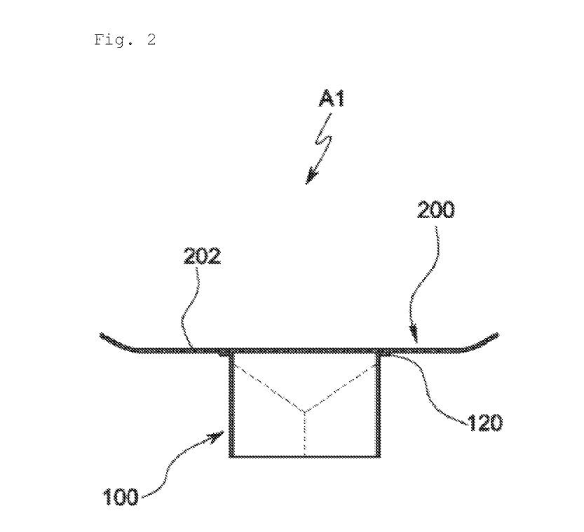

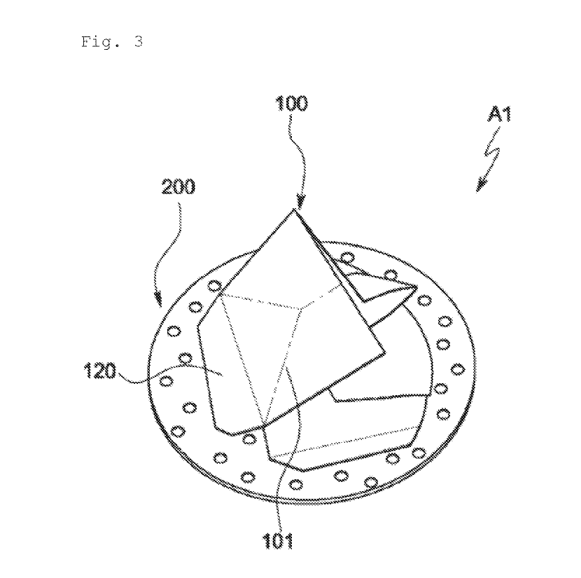

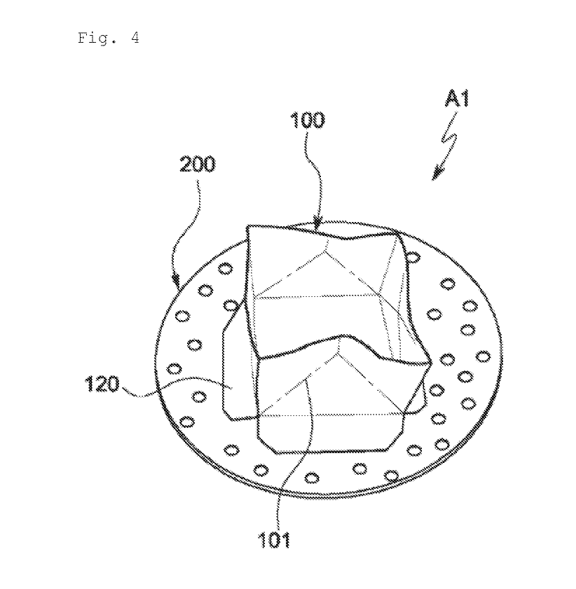

FIG. 1 is an exploded perspective view of a disposable tray for a food steamer, according to a first embodiment of the present invention. FIG. 2 is a combined cross-sectional view of the disposable tray according to the first embodiment of the present invention. FIG. 3 is a view illustrating a folded state of a support of the disposable tray according to the first embodiment of the present invention. FIG. 4 is a view illustrating an unfolded state of the support.

As illustrated in FIGS. 1 to 3, a disposable tray Al for a food steamer, according to the present invention includes: a support 100 standing upright such that a lower end portion thereof is supported in a steamer; and an upper plate 200 horizontally disposed on an upper portion of the support 100, having a certain area, and provided with a plurality of fine through-holes 202 formed therein, in which the support 100 is provided with adhesion pieces 120 at an upper portion thereof and is adhered to a bottom surface of the upper plate 200.

Preferably, the upper plate 200 is formed of a cheap paper material to be thrown away after one use. The upper plate 200 may also be formed of pulp board coated with polyethylene or formed of aluminum foil.

The support 100 may have a tetragonal, polygonal, or cylindrical shape and be formed of cardboard having a predetermined thickness, thereby achieving supporting force. In addition, the support 100 is preferably formed of pulp board coated with polyethylene. Thus, the support 100 may have waterproofness and may stably maintain the coated state even at high temperature. In addition, an outer surface of the support 100, in particular, a lower end thereof, is coated with heat-resistant synthetic resin to form a finished portion 109 so as to prevent the support 100 from sinking in water. The lower end of the support 100 is supported on a bottom surface of a container, and the container is filled with water and thus the finished portion 109 is formed so as to prevent the support 100 from sinking in the water in a state of being placed in the water for a certain period of time. The support 100 may also be formed of aluminum foil. When the support 100 and the upper plate 200 are formed of aluminum foil, the support 100 and the upper plate 200 are coupled to each other in an integrated form and using an insertion assembly method or a folding method, instead of using an adhesion method.

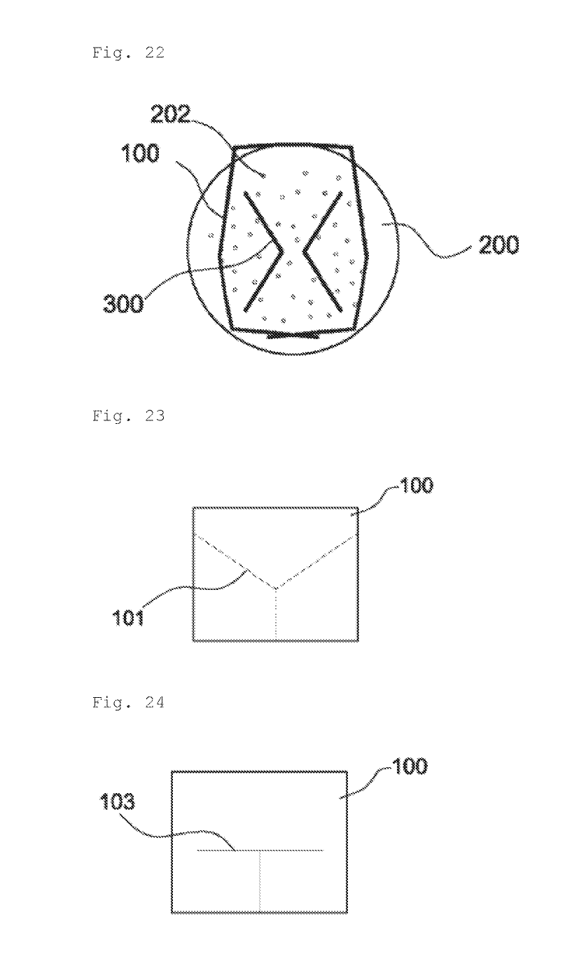

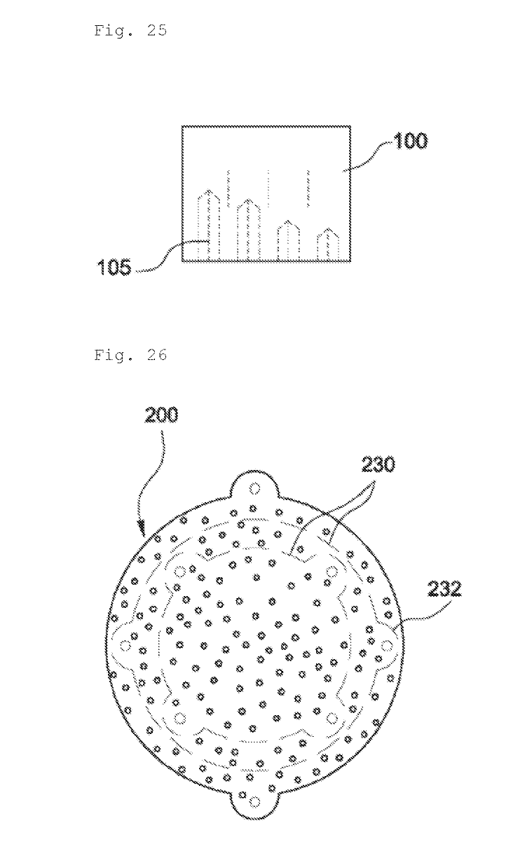

Meanwhile, as illustrated in FIG. 22, the disposable tray further includes an auxiliary support 300 inserted into the support 100 and supporting a center of the upper plate 200. The auxiliary support 300 is formed by vertically folding cardboard in a “>” shape such that an upper end thereof supports the bottom surface of the upper plate 200 and a lower end thereof supports the bottom surface of the container.

Meanwhile, as illustrated in FIG. 23, the support 100 may have a tetragonal, polygonal or cylindrical shape and is provided at sidewalls thereof with a plurality of folding lines 101 to allow the support 100 to be folded.

Thus, the support 100 may be stored after being folded along the folding lines 101 so that the volume of the support 100 is decreased and, when used, the support 100 is unfolded and stands upright.

Alternatively, as illustrated in FIG. 24, the support 100 has a tetragonal, polygonal or cylindrical shape and is provided at side walls thereof with a plurality of cutting lines 103 to allow the support 100 to be folded and stand upright.

Meanwhile, as illustrated in the accompanied figures, the support 100 is provided at sidewalls thereof with irregular folding lines 105 to be folded inward or outward to be corrugated, and thus, the support 100 may have enhanced rigidity.

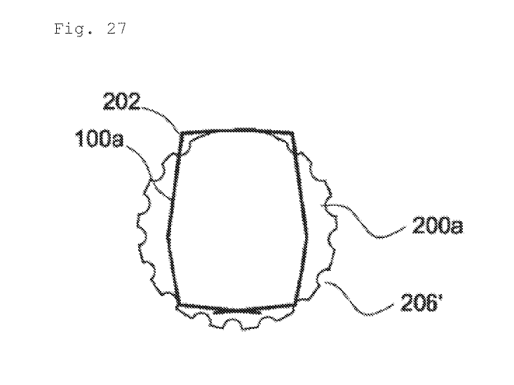

Meanwhile, the upper plate 200 has a circular disk form. However, the shape of the upper plate 200 is not limited to the circular form. In addition, as illustrated in FIG. 26, the upper plate 200 is provided with a plurality of cutting portions 230 having three different diameters according to large, medium and small sizes and formed in a concentric circle form. In this regard, the number of the cutting portions having the corresponding diameter may be increased or decreased. The plurality of cutting portions 230 are formed such that cutting holes in a dotted line form are consecutively formed, and the upper plate 200 is provided at one side thereof with a handle part 232 having a semicircular shape, and the handle part 232 has a through-hole. Alternatively, as illustrated in FIG. 27, an upper plate 200a may have no through-hole at a center thereof and be provided with through-holes 206′ in an outer circumferential surface thereof, and steam is discharged through the through-holes 206′ formed in the outer circumferential surface thereof. This is equally applied to other embodiments described below and detailed description thereof will not be provided again.

### Second Embodiment

According to another embodiment, as illustrated in FIG. 5, a disposable tray for a food steamer includes: a support 100 standing upright such that a lower end portion thereof is supported in a steamer; and an upper plate 200 horizontally disposed on an upper portion of the support 100, having a certain area, and provided with a plurality of fine through-holes 202 formed therein, in which the support 100 is provided, at an upper end thereof, with coupling portions 130 protruding therefrom, and the upper plate 200 is provided with slits 210 into which the respective coupling portions 130 are inserted so that the support 100 and the upper plate 200 may be separated from or coupled to each other.

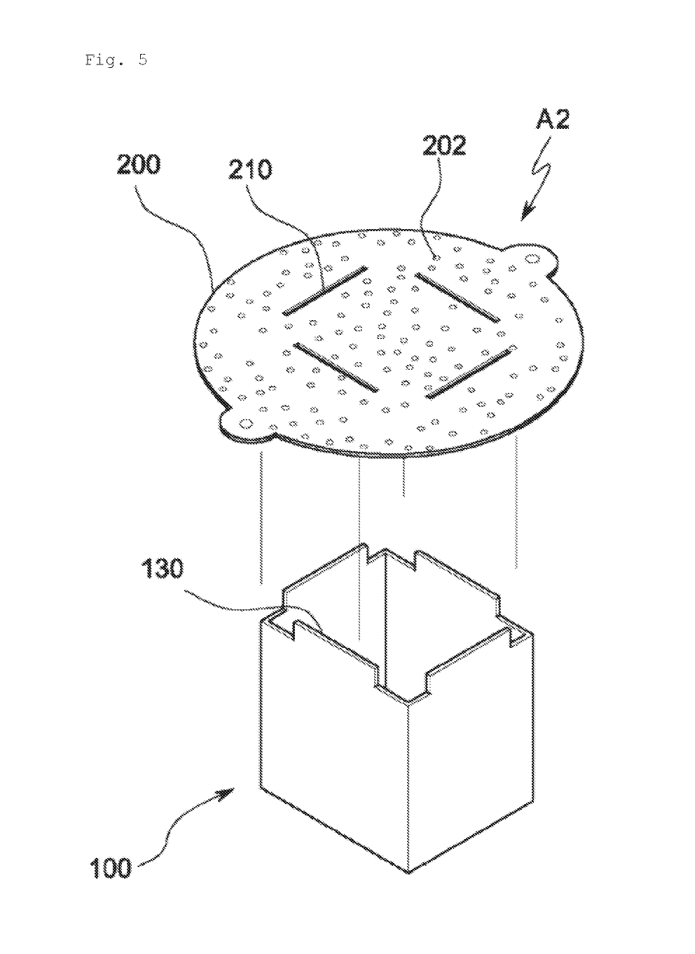

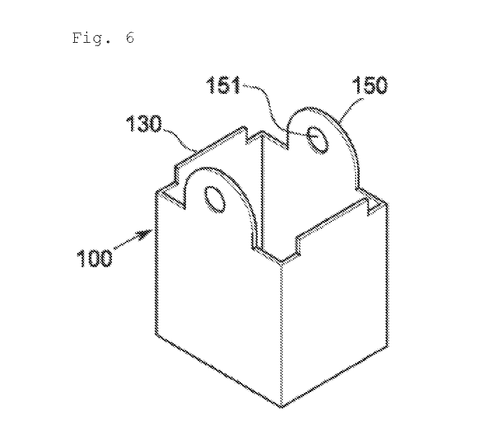

As illustrated in FIG. 6, some of the coupling portions 130 formed at the upper end of the support 100 protrude farther than the other coupling portions 130 to thereby form handles 150. Each handle 150 has a circular form and is provided with a through-hole 151 at a center thereof to form a ring shape so that the handles 150 can be grabbed or lifted with chopsticks inserted therethrough.

### Third Embodiment

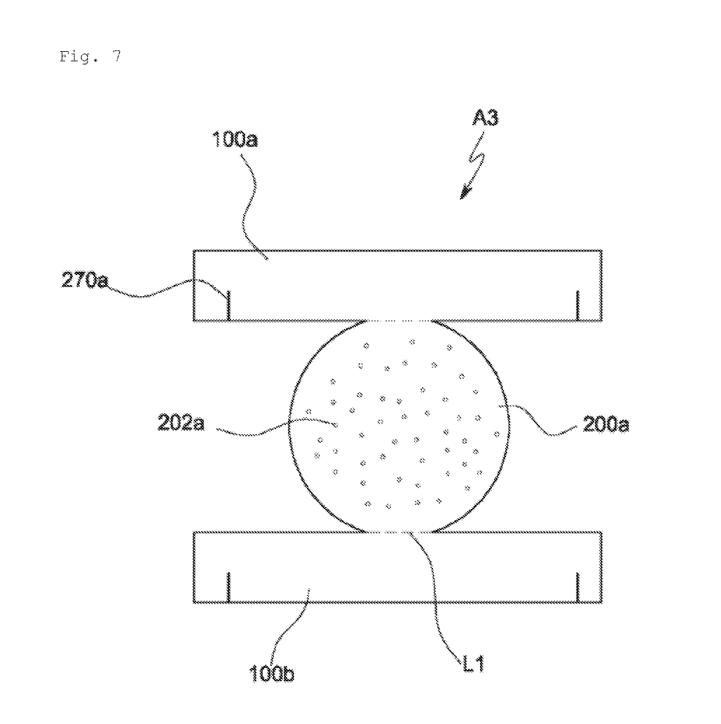

FIG. 7 is a development view of a disposable tray for a food steamer, according to a third embodiment of the present invention. FIGS. 8 and 9 are a development view and a combined perspective view that illustrate the disposable tray according to the third embodiment of the present invention.

The disposable tray A3 according to the third embodiment includes: an upper plate 200a having a certain area and a plurality of through-holes 202a formed therein; and a plurality of supports 100a and 100b symmetrically disposed at opposite sides of the upper plate 200a and provided with insertion grooves 270a at respective opposite ends thereof. Folding lines L1 are formed at connection portions between the upper plate 200a and each of the supports 100a and 100b, the supports 100a and 100b are folded along the folding lines L1 to be configured opposite to each other in perpendicular to the upper plate 200a, and opposite sides of the supports 100a and 100b intersect each other and insertion grooves 270a at the corresponding opposite sides thereof are combined with each other to thereby form sidewalls so that the disposable tray A3 stands upright.

Thus, the folding lines L1 formed at connection portions between the upper plate 200a and each of the supports 100a and 100b are folded into a straight line, formation thereof is simple, and the folding lines L1 are not forcibly folded, thus having enhanced durability. The upper plate 200a has a circular shape, but the present invention is not limited thereto.

Meanwhile, as illustrated in FIG. 8, a disposable tray A3′ for a food steamer, as another example of the third embodiment includes: the upper plate 200a having a plurality of through-holes 202a and a tetragonal shape; first and second supports 100a and 100b symmetrically disposed at opposite sides of the upper plate 200a and provided with insertion grooves 270a at opposite sides of each thereof, in which a cutting line C1 and a folding line L2 are formed at a connection portion between each of the first and second supports 100a and 100b and the upper plate 200a, and folding lines L3 extending from opposite ends of the folding line L2 are formed perpendicular to the first and second supports 100a and 100b.

Thus, as illustrated in FIG. 9, the first and second supports 100a and 100b stand upright in perpendicular to the upper plate 200a and are bent in an inclined form to form an approximately hexagonal shape, and then opposite sides of the first and second supports 100a and 100b intersect each other and the corresponding insertion grooves 270a are combined with each other to thereby form sidewalls.

### Fourth Embodiment

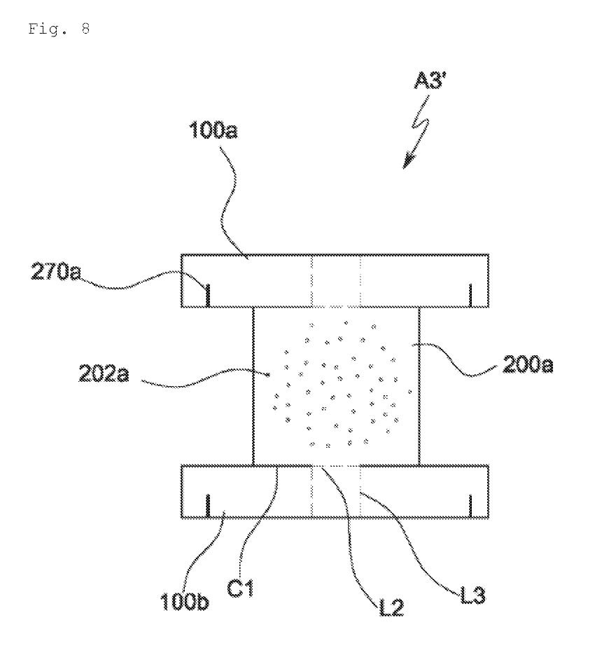

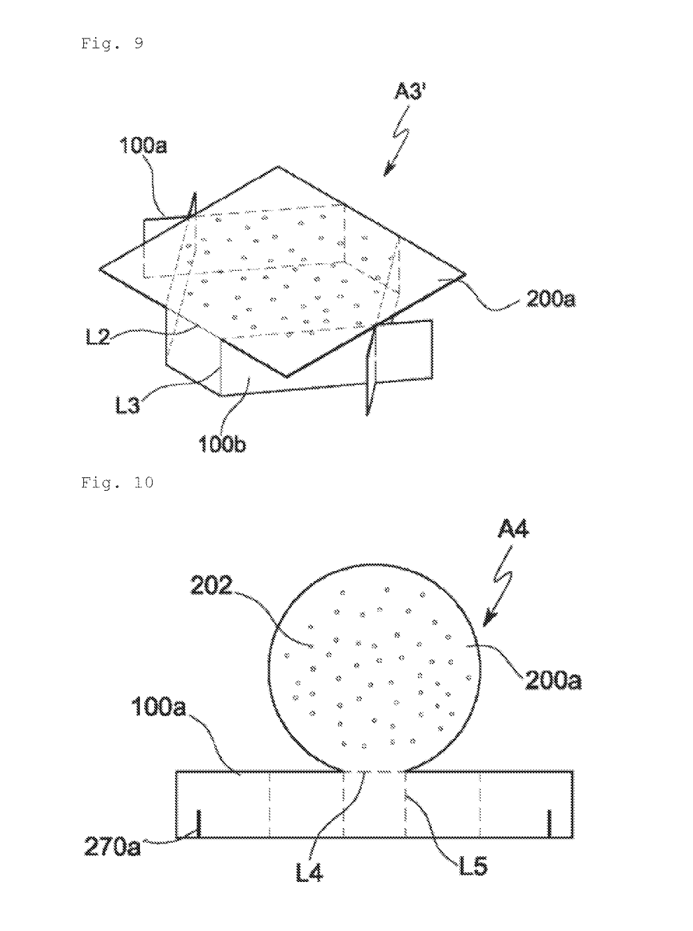

FIGS. 10 and 11 are a development view and a combined bottom view that illustrate a disposable tray for a food steamer, according to a fourth embodiment of the present invention.

A disposable tray A4 for a food steamer according to the fourth embodiment includes: the upper plate 200a having a certain area and the through-holes 202 formed therein; and the support 100a connected to one side of the upper plate 200a and provided with the insertion grooves 270a at opposite sides thereof, in which a folding line L2 is formed at a connection portion between the support 100a and the upper plate 200a, the support 100a is folded along the folding line L2 to stand upright in a direction perpendicular to the upper plate 200a, and opposite sides of the support 100a intersect each other and the insertion grooves 270a formed at the respective opposite sides thereof are combined with each other to thereby form sidewalls.

As illustrated in FIG. 11, the upper plate 200a has a circular form, and the support 100a is bent into an approximately hexagonal form and stands upright on an inner side of the upper plate 200a.

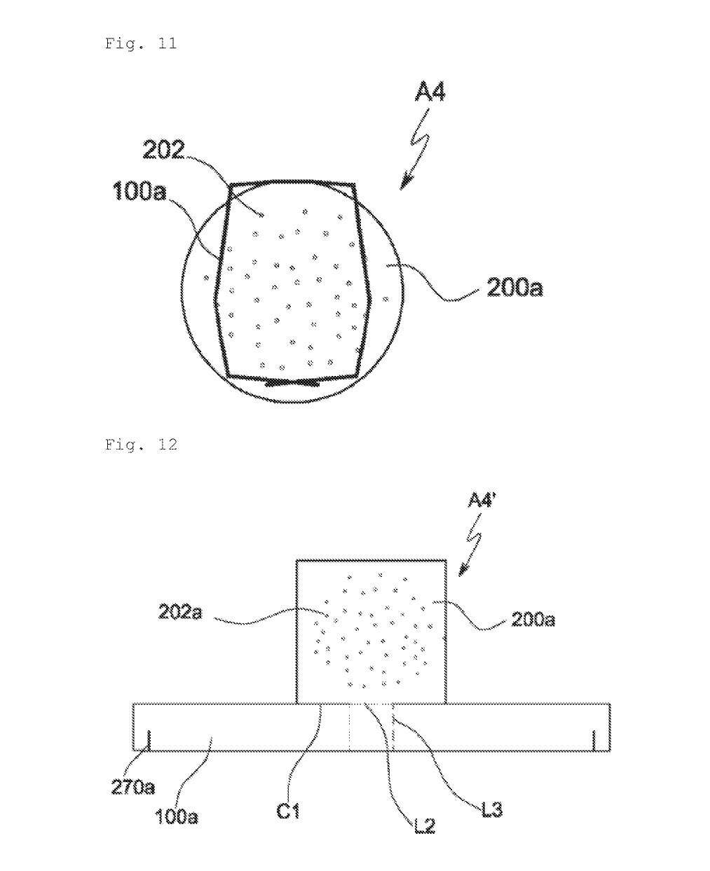

Meanwhile, as illustrated in FIG. 12, in a disposable tray for a food steamer, as another example of the fourth embodiment, the upper plate 200a has a tetragonal shape, the cutting line C1 and the folding line L2 are formed at a connection portion between the support 100a and the upper plate 200a, and the folding lines L3 extending from opposite ends of the folding line L2 are formed perpendicular to the support 100a.

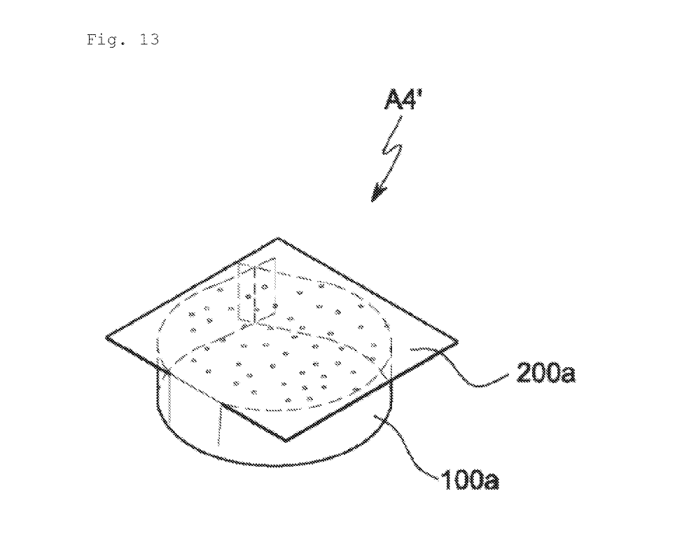

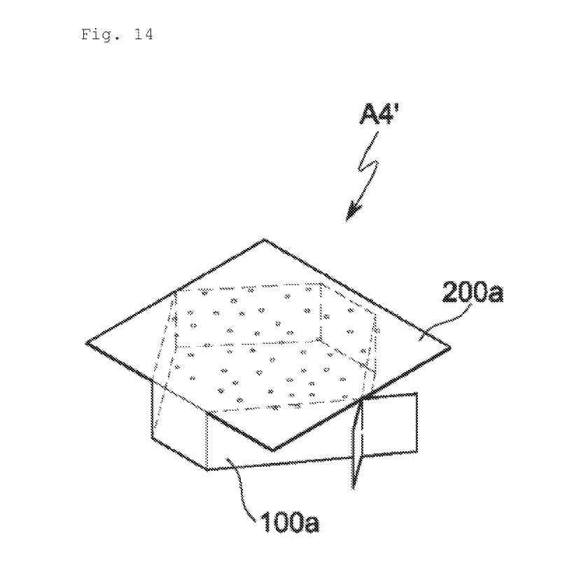

Thus, as illustrated in FIGS. 13 and 14, the support 100a is folded along the folding line L2 to have a cylindrical form and then opposite sides thereof are combined with each other by intersection, or the support 100a stands upright by folding along the folding line L2 and then is bent into a hexagonal form and opposite sides thereof intersect each other and the insertion grooves 270a formed at the respective opposite sides thereof are combined with each other to thereby form sidewalls and, as a result, the support 100a may stand upright on an inner side of the upper plate.

### Fifth Embodiment

FIG. 15 illustrates a disposable tray A5 for a food steamer, according to a fifth embodiment of the present invention. The disposable tray A5 includes: the upper plate 200a having a certain area and the through-holes 202 formed therein; and the support 100a connected to one side of the upper plate 200a and provided with the insertion grooves 270a at opposite sides thereof, in which a folding hole 205a′ is formed at a connection portion between the support 100a and the upper plate 200a, the support 100a is folded along the folding hole 205a′ to stand in a direction perpendicular to the upper plate 200a, opposite sides of the support 100a intersect each other and the insertion grooves 270a formed at the respective opposite sides thereof are combined with each other to thereby form sidewalls and, as a result, the disposable tray A5 stands upright. Alternatively, as illustrated in FIG. 27, the upper plate 200a may have no through-hole at a center thereof and be provided with through-holes 206′ in an outer circumferential surface thereof, and steam is discharged through the through-holes 206′ formed in the outer circumferential surface thereof.

### Sixth Embodiment

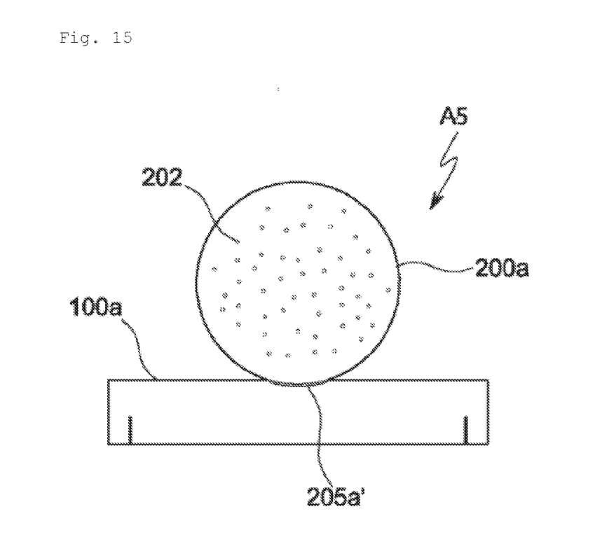

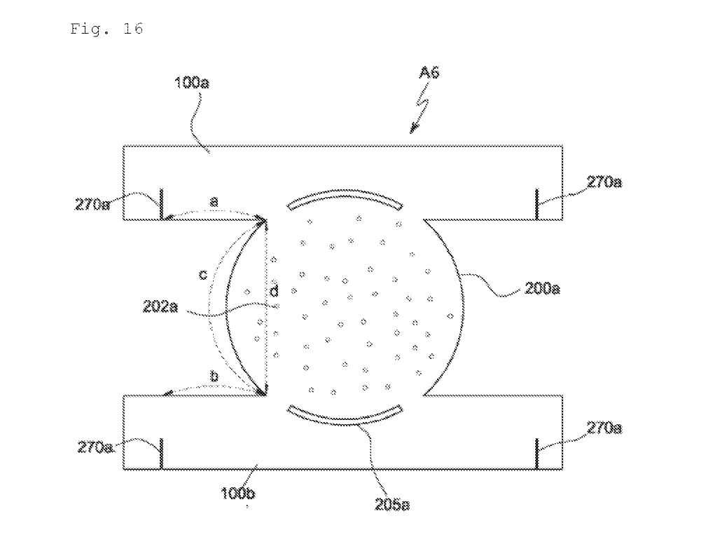

FIG. 16 is a development view of a disposable tray for a food steamer, according to a sixth embodiment of the present invention. FIG. 17 is an assembled perspective view of the disposable tray according to the sixth embodiment of the present invention. FIG. 18 is a bottom view of the disposable tray of FIG. 16.

As illustrated in FIGS. 16 to 18, the disposable tray A6 according to the sixth embodiment of the present invention includes: the upper plate 200 having a certain area; the first and second supports 100a and 100b symmetrically disposed at opposite sides of the upper plate 200 and provided with the insertion grooves 270a at opposite sides of each thereof, in which the first support 100a and the second support 100b are configured opposite to each other to stand upright in perpendicular to the upper plate 200a, and opposite sides of the first and second supports 100a and 100b intersect each other and the insertion grooves 270a formed at the respective opposite sides thereof are combined with each other to thereby form sidewalls.

Each of the first support 100a and the second support 100b has a rectangular shape having a certain area and a certain length. In addition, the insertion grooves 270a are vertically formed to a large length in each of the first and second supports 100a and 100b.

In addition, the upper plate 200a of a disk type is partially connected between the first support 100a and the second support 100b that are symmetrically disposed, and a folding hole 205a having a sectoral shape is formed at a connection portion between the upper plate 200a and each of the first and second supports 100a and 100b to thereby facilitate a folding operation and more easily form a right angle when folded.

The upper plate 200a is provided with the fine through-holes 202a formed therein, and the shape thereof is not particularly limited to a circular form. The upper plate 200a is provided, at opposite sides thereof, with handles 206a protruding therefrom.

Preferably, as illustrated in FIG. 16, a length of an a+b section is larger than that of a d section and smaller than that of a circular arc represented by c. Thus, as illustrated in FIG. 18, the first support 100a and the second support 100b stand perpendicular to the upper plate 200 at opposite sides thereof and then the insertion grooves 270a of the respective first and second supports 100a and 100b are combined with each other to thereby form sidewalls in a state in which the first and second supports 100a and 100b stand upright on an inner side of the upper plate 200 and, accordingly, the first and second supports 100a and 100b may rigidly support the upper plate 200a.

### Seventh Embodiment

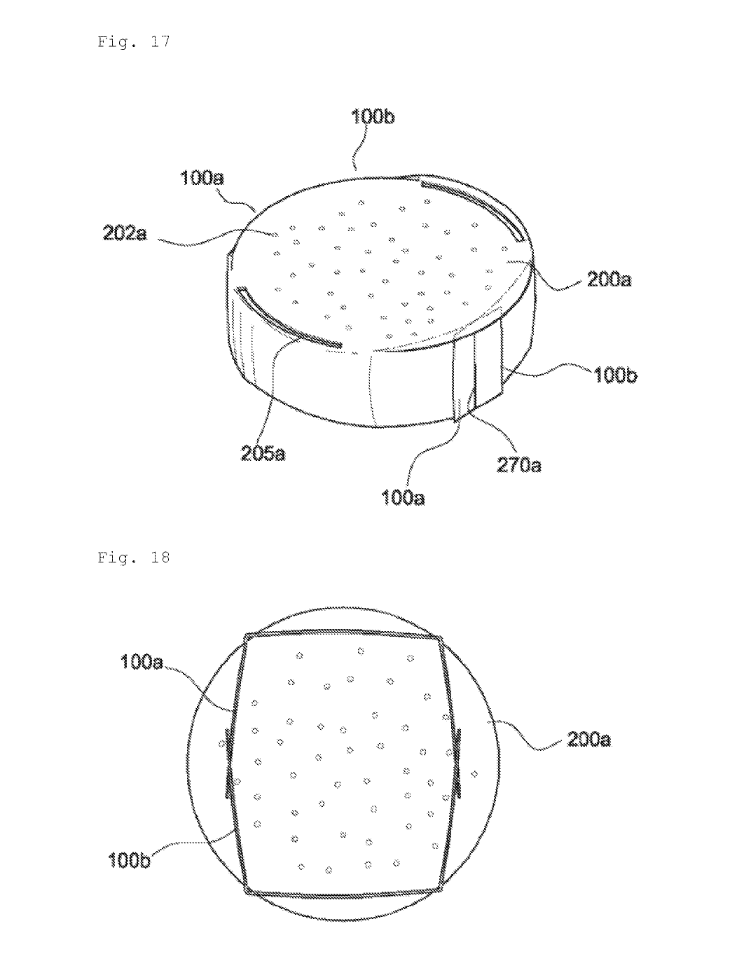

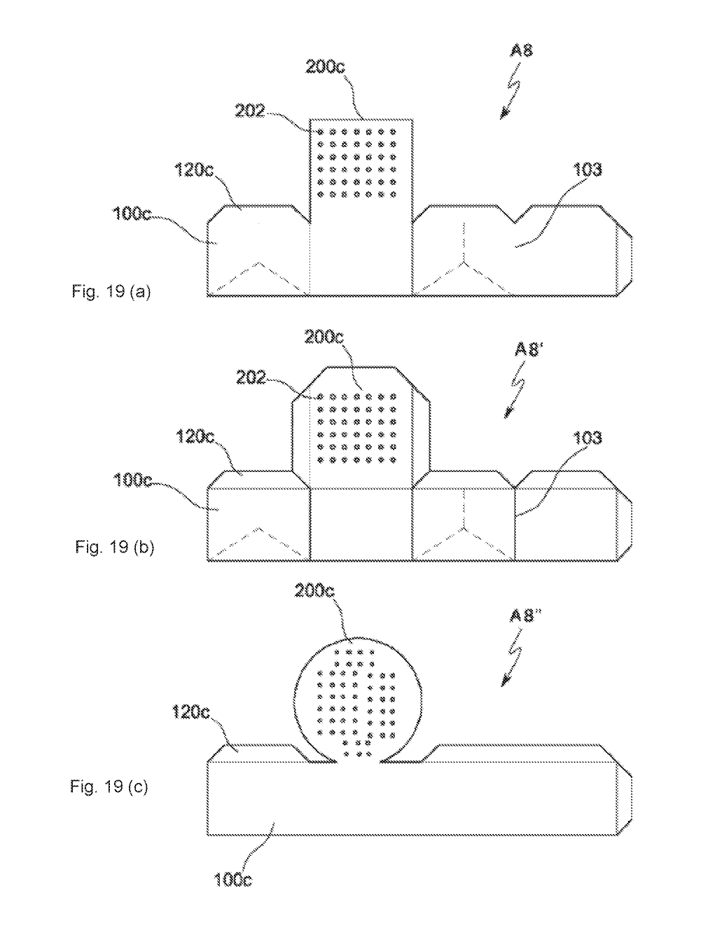

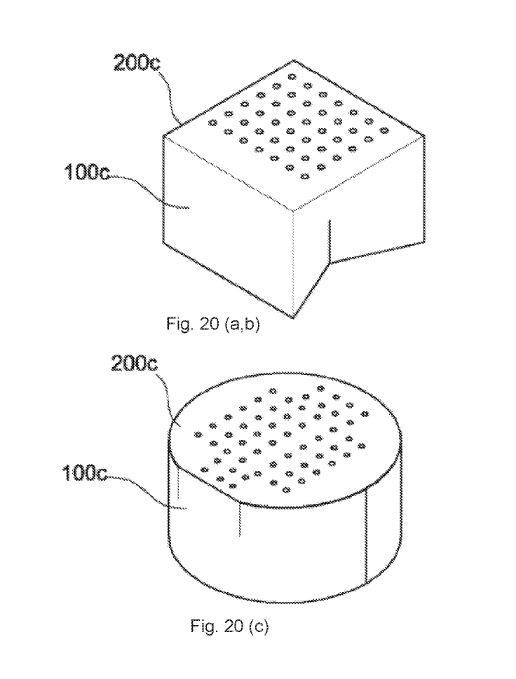

FIG. 19 is a development view of a disposable tray for a food steamer, according to a seventh embodiment of the present invention. FIG. 20 is a combined perspective view of the disposable tray of FIG. 19.

As illustrated in FIG. 19, the disposable tray A7 according to the seventh embodiment includes: an upper plate 200c having a certain area and the through-holes 202 formed therein; and a support 100c connected to one side of the upper plate 200c and provided with adhesion pieces 120c formed at an upper portion of one side thereof, in which folding lines 103 are formed at connection portions between the support 100c and the upper plate 200c, the support 100c is folded along the folding lines to stand in a direction perpendicular to the upper plate 200c, and the adhesion pieces 120c are adhered to a bottom surface of the upper plate 200c to thereby complete assembly into a polyhedral form. Thus, the support 100c is folded to form sidewalls and the upper plate 200c is adhered to the upper portion thereof, thereby completing assembly of the disposable tray A7. The support 103 is provided at sidewalls thereof with irregular folding lines to be folded inward or outward to be corrugated, and thus, the support 103 may have enhanced rigidity.

The upper plate 200c has various shapes, e.g., a tetragonal shape, a circular shape, and the like, and the adhesion pieces 120c may be formed on any one side of the support and the upper plate or formed at both the support and the upper plate. According to the shape of the upper plate 200c, the support 100c is assembled into a polyhedron such as a hexahedron (see FIG. 20 a, b) or a cylinder (see FIG. 20c). Although not shown in the drawings, when the upper plate has a triangle form, the support may have a triangular prism shape. The support 100c has a tetragonal, polygonal or cylindrical form and is provided with the folding lines 101 at the sidewalls thereof to be folded.

Thus, the support 100c may be stored after being folded along the folding lines 101 so that the volume of the support 100c is decreased and, when used, the support 100c is unfolded and stands upright. The support 100c has a tetragonal, polygonal or cylindrical form and is provided with the cutting lines 103 at sidewalls thereof to be folded and stand upright. The support 100c is provided at sidewalls thereof with the irregular folding lines 105 to be folded inward or outward to be corrugated, and thus, the support 100c may have enhanced rigidity.

### Eighth Embodiment

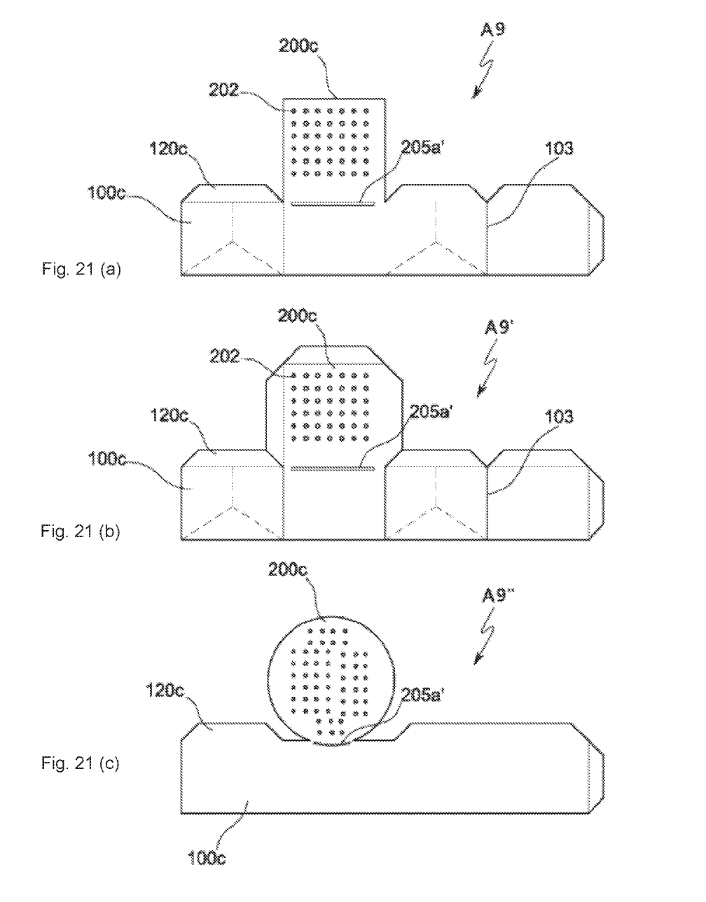

FIG. 21 is a development view of a disposable tray for a food steamer, according to an eighth embodiment of the present invention.

The disposable tray includes: the upper plate 200c having a certain area and through-holes formed therein; and the support 100c connected to one side of the upper plate 200c and provided with the adhesion pieces 120c at an upper portion of one side thereof, in which a folding hole 205a′ is formed at a connection portion between the support 100c and the upper plate 200c, the support 100c is folded along the folding hole 205a′ to stand in a direction perpendicular to the upper plate 200c, and the adhesion pieces 120c are adhered to a bottom surface of the upper plate 200c to thereby complete assembly into a polyhedral form. The support 100c is provided at sidewalls thereof with irregular folding lines to be folded inward or outward to be corrugated, and thus, the support 100c may have enhanced rigidity.

In the first to eighth embodiments, as illustrated in FIG. 22, the disposable tray may further include the auxiliary support 300 inserted into the support 100a and supporting a center of the upper plate 200a. The auxiliary support 300 is formed by vertically folding cardboard in a “>” shape such that an upper end thereof supports the bottom surface of the upper plate 200a and a lower end thereof supports a bottom surface of a container.

While the present invention has been described with reference to the aforementioned exemplary embodiments, it should be understood by those skilled in the art that various changes and modifications may be made without departing from the spirit and scope of the invention. In addition, these changes and modifications are intended to be within the scope of the claims appended hereto.

### INDUSTRIAL APPLICABILITY

A simple disposable tray for a food steamer according to the present invention is placed in a cooking pot or a microwave oven and allows food to be placed thereon to be cooked by steam or a heat source.

1. A disposable tray for a food steamer, comprising:
an upper plate having a certain area and with a plurality of through-holes formed therein; and
a support vertically standing below the upper plate to form sidewalls, a lower end portion thereof being supported in a container,
wherein the upper plate is provided with a plurality of cutting portions having different diameters according to sizes in a concentric circle form, the cutting portions being configured such that cutting holes in a dotted line form are consecutively formed, and
the support is provided with adhesion pieces at an upper portion thereof, the adhesion pieces being adhered to a bottom surface of the upper plate.

2. A disposable tray for a food steamer, comprising:
an upper plate having a certain area and with a plurality of through-holes formed therein; and
a support vertically standing below the upper plate to form sidewalls, a lower end portion thereof being supported in a container,
wherein the support is provided, at an upper end thereof, with coupling portions protruding therefrom, and the upper plate is provided with slits into which the respective coupling portions are inserted so that the support and the upper plate are separated from or coupled to each other,
wherein some of the coupling portions formed at the upper end of the support protrude farther than the other coupling portions to thereby form handles.

3. A disposable tray for a food steamer, comprising:
an upper plate having a certain area and with a plurality of through-holes formed therein; and
a plurality of supports connected to opposite sides of the upper plate and provided with insertion grooves at respective opposite ends thereof,
wherein folding lines are formed at connection portions between the upper plate and each support, the supports are folded along the folding lines to stand perpendicular to the upper plate, opposite end portions of the supports intersect each other and the insertion grooves at the corresponding opposite sides thereof are combined with each other to thereby form sidewalls so that the disposable tray stands upright,
wherein irregular folding lines are formed at the sidewalls of the supports to be folded inward or outward to be corrugated, thus enhancing rigidity of the supports.

4. A disposable tray for a food steamer, comprising:
an upper plate having a certain area and with a plurality of through-holes formed therein; and
a support connected to one side of the upper plate and provided with insertion grooves at opposite end portions thereof,
wherein a folding line is formed at a connection portion between the support and the upper plate, the support is folded along the folding line to stand perpendicular to the upper plate, opposite end portions of the support intersect each other and the insertion grooves formed at the opposite end portions thereof are combined with each other to thereby form a sidewall so that the support stands upright,
wherein irregular folding lines are formed at the sidewall to be folded inward or outward to be corrugated, thus enhancing rigidity of the support.

5. A disposable tray for a food steamer, comprising:
an upper plate having a certain area and with a plurality of through-holes formed therein; and
a support connected to one side of the upper plate and provided, at opposite end portions thereof, with insertion grooves,
wherein a folding hole is formed at a connection portion between the support and the upper plate, the support is folded along the folding hole to stand perpendicular to the upper plate, and opposite end portions of the support intersect each other and the insertion grooves are combined with each other to form a sidewall so that the support stands upright on an inner side of the upper plate.

6. A disposable tray for a food steamer, comprising:
an upper plate having a certain area and with a plurality of through-holes formed therein; and
first and second supports symmetrically disposed at opposite sides of the upper plate to have a tetragonal shape and provided with insertion grooves at opposite sides of each thereof,
wherein the first support and the second support are configured opposite to each other in order to stand upright perpendicular to the upper plate, and opposite end portions of the first and second supports intersect each other and the insertion grooves formed at the respective opposite sides thereof are combined with each other to thereby form sidewalls.

7. A disposable tray for a food steamer, comprising:
an upper plate having a certain area and with a plurality of through-holes formed therein; and
a support connected to one side of the upper plate and provided with adhesion pieces formed at an upper portion of one side thereof,
wherein folding lines are formed at connection portions between the support and the upper plate, the support is folded along the folding lines to stand in a direction perpendicular to the upper plate to thereby form sidewalls, and the adhesion pieces are adhered to a bottom surface of the upper plate to thereby complete assembly into a polyhedral form,
wherein irregular folding lines are formed at the sidewalls of the support to be folded inward or outward to be corrugated, thus enhancing rigidity of the support.

8. A disposable tray for a food steamer, comprising:
an upper plate having a certain area and with a plurality of through-holes formed therein; and
a support connected to one side of the upper plate and provided with adhesion pieces at an upper portion of one side thereof,
wherein a folding hole is formed at a connection portion between the support and the upper plate, the support is folded along the folding hole to stand in a direction perpendicular to the upper plate to form a sidewall, and the adhesion pieces are adhered to a bottom surface of the upper plate to thereby complete assembly into a polyhedral form,
wherein irregular folding lines are formed at the sidewall of the support to be folded inward or outward to be corrugated, thus enhancing rigidity of the support.

9. The disposable tray of claim 6, wherein folding holes or folding lines are formed at connection portions between the upper plate and each of the supports.

10. The disposable tray of claim 1, to wherein the support and the upper plate comprise a paper material.

11. The disposable tray of claim 1, wherein the support and the upper plate are coated with heat-resistant synthetic resin.

12. The disposable tray of claim 1, further comprising an auxiliary support inserted into the support and supporting a center of the upper plate, wherein the auxiliary support is formed by vertically folding cardboard in a “>” shape such that an upper end thereof support a bottom surface of the upper plate and a lower end thereof supports a bottom surface of a container.

13. The disposable tray of claim 1, wherein irregular folding lines are formed at the sidewall of the support to be folded inward or outward to be corrugated, thus enhancing rigidity of the support.

14. The disposable tray of claim 2, wherein the upper plate is provided with a plurality of cutting portions having different diameters according to sizes in a concentric circle form, the cutting portions being configured such that cutting holes in a dotted line form are consecutively formed, and the upper plate is provided at one side thereof with a handle part.

15. The disposable tray of claim 1, wherein the support has a tetragonal, polygonal or cylindrical form and is provided with a plurality of folding lines or cutting lines formed thereat to be folded.
